(19) United States
(12) Patent Application Publication
(10) Pub. No.: US 2004/0248737 A1
(43) Pub. Date: Dec. 9, 2004

(54) Growth regulator and process for growth regulation of plant

(76) Inventors: Yutaka Matsugu, Kanagawa (JP); Koji Hasegawa, Ibaraki (JP)

Correspondence Address: Sheldon J Moss, Margaret A Burke Yumi Yerks, Apartment 412 North, 2111Jefferson Davis Highway, Arlington, VA, 22202, US

(21) Appl. No.: 10/483,044

(22) PCT Filed: Jul. 10, 2002
(86) PCT No.: PCT/JP02/07018

(30) Foreign Application Priority Data
Jul. 10, 2001 (JP) 2001-209016
Dec. 28, 2001 (JP) 2001-399226
Apr. 12, 2002 (JP) 2002-111224

(51) Int. Cl. A01N 25/00

(52) U.S. Cl. 504/116.1

(57) ABSTRACT

The present invention relates to growth regulators of a plant and processes for regulating the same, and more particularly, relates to a technique to regulate the growth of a plant using a substance which is friendly to the global environment. A growth regulator of a plant comprising NaHCO₃ and/or KHCO₃ as a principal active ingredient is provided.

### BACKGROUND OF THE INVENTION

1. Field of the Invention

The present invention relates to growth regulators of a plant and processes for regulating the same, and more particularly, to a technique to regulate the growth of a plant using a substance which is friendly to the global environment.

2. Description of the Related Art

Conventionally, plant hormones, or plant growth stimulators as well as suppressors and the like have been utilized as agents for the growth stimulation or suppression of a plant in the cultivation of a variety of crop plants. Furthermore, phytic acid, choline and the like have been also known in addition to the plant hormones. However, these substances are expensive, and thus substances that are low in price upon use have been desired. Additionally, some of the plant hormones have teratogenicity to the human body, therefore, safe substances to the human body have been sought.

Although various proposals have been made heretofore with regard to the growth stimulators of plants, many of them have been directed to chemically synthesized agents. Thus, processes in which such an agent is diluted and sprayed have been predominantly applied. However, organic farming methods have become popular recently, in which compost or a natural organic fertilizer is used. Also for growth accelerators of a plant, attempts have been made to develop those which exert no influences on soil or environmental aspects.

### SUMMARY OF THE INVENTION

An object of the present invention is to provide a process for regulating the growth of a plant while avoiding problems involved in safety of pesticides and the like, and taking into account of the global environment. The process employs an entirely novel compound as a regulator.

First aspect of the invention relates to a growth regulator of a plant comprising NaHCO₃ and/or KHCO₃ as a principal active ingredient. Further, depending on the circumstances, a growth regulator of a plant is provided in which a plant hormone (preferably, auxin) is included as an active ingradient.

Second aspect of the invention relates to a process for the growth regulation of a plant in which 0.003 to 1% by weight of NaHCO₃ and/or KHCO₃ is included in a germination and nursery bed of the plant. Further, depending on the circumstances, a process for the growth regulation of a plant is provided in which a plant hormone is included at 10⁻³ to 10⁻⁷ M.

As already proposed, the present inventors have developed on dwarfing methods of a plant using sodium bicarbonate (NaHCO₃), and have focused attention to the point that sodium bicarbonate is soluble in water, harmless to human and animals, friendly to the global environment, and available at comparatively low cost. Thus, the inventors conducted a variety of investigations, and unexpectedly found that sodium bicarbonate has an action on a plant to accelerate the germination and growth of the plant. Accordingly, the inventors achieved the invention through further evolving the previous proposals to provide growth regulators of a plant and processes for the growth regulation of a plant, which are inexpensive and safe to the human body.

The plant growth regulator used in the invention includes water soluble NaHCO₃ (sodium bicarbonate) and/or KHCO₃ as a principal active ingredient. The invention is further explained hereinafter with a central focus on sodium bicarbonate. Because an aqueous solution of sodium bicarbonate is almost neutral (pH 8.2) even if it is saturated, it hardly affects the soil. Moreover, sodium bicarbonate runs off with rainwater after the treatment to a plant. Accordingly, this substance is friendly to the global environment, and thus needless to add, can be subjected to the treatment without adversely affecting it. Such sodium bicarbonate and the like which can be used may be any known one, which may contain impurities, as long as adverse effects are not exerted to the environment with departing from the object of the invention. As a matter of course, combined use with ingredients of a fertilizer such as nitrogen, phosphorus and potassium, as well as other plant growth regulator is allowed. Commercially available sodium bicarbonate which can be used in the invention includes for example, “ARMEX”, trade name by Church & Dwight Co., Inc. Although this article contains a slight amount of Na₂CO₃, Ca, Mg, SiO₂ and the like, it can be used as a plant growth regulator without any problems even though such impurities coexist. Of course, the sodium bicarbonate of the invention is not limited thereto. Also in respect of KHCO₃, influences on the global environment are hardly exerted, almost similarly to sodium bicarbonate.

When the sodium bicarbonate or the like of the invention is used by adding to water upon hydroponics, the concentration for the treatment varies depending on the plant type, as a matter of course, however, the concentration will be 0.003 to 1% by weight, and preferably in the range of 0.01 to 0.1% by weight. In other words, the concentration at a higher range functions as a factor to act for inhibiting a plant growth, and the concentration within a predetermined range leads to expectation to the growth acceleration effects on a plant, resulting in greater height, more rapid growth, as well as upsized fruits, and increased number of fruits. The concentration range is determined ad libitum taking into account that too high concentration is disadvantageous because germination does not occur, and that too low concentration does not achieve the expected effects. Sodium bicarbonate and KHCO₃ may be used in combination of course, and the ratio of them is appropriately determined depending on the plant to be applied through determining the concentration ad libitum.

In accordance with the invention, to use a plant hormone in combination with sodium bicarbonate or KHCO₃ is also a preferable means. For example, indole-3-acetate (IAA) that is a plant hormone suppresses the growth at a relatively high concentration, however, it exhibits a growth acceleration action at a lower concentration (approximately 10⁻⁴ to 10⁻⁷ M). Although the system thereof has not been completely elucidated, plants may involve a growth acceleration mechanism which is stimulated by efflux/influx of Na⁻ or K⁺, or a mechanism to induce the activation of a growth acceleration hormone.

Plant hormones which may be used include auxin, for example, 2,4-D (2,4-dichlorophenoxy acetate), IAA (indole-3-acetate), IBA (indole-3-butyrate), NAA (1-naphthalene acetate), 2,4,5-T (2,4,5-trichlorophenoxy acetate), picloram (4-amino-3,5,6-trichloropyridine-2-carboxylate), dicamba (3,6-dichloro-O-anisate), naphthaleneacetamide, 5-chloro-1H-indazol-3-yl ethyl acetate, MCPA (4-chloro-O-tolyloxyacetate), 2,3,6-TBA (2,3,6-trichlorobenzoate), dichloroprop [2-(2,4-dichlorophenoxy)propionate], mecoprop [2-(4-chloro-2-methylphenoxy)propionate], 2,4-DB [4-(2,4-dichlorophenoxy)butyrate], MCPB [4-(4-chloro-O-tolyloxy)butyrate], phenoprop [2-(2,4,5-trichlorophenoxy)propionate] and the like. These may be used alone or in combination of two or more.

Further, as cytokinin, for example, kinetin (6-furfurylaminopurine), BA (benzyladenine), 4-PU (4-pyridylphenylurea), zeatin [4-hydroxy-3-methyl(E)-2-butenylaminopurine], dihydrozeatin (4-hydroxy-3-methylbutylaminopurine), 2-isopentenyladenine, 2-isopentenyladenosine, transribosylzeatin [6-(4-hydroxy-3-methyl-(E)-2-butenylamino)-9-β-D-ribofuranosylpurine], CPPU [N-(2-chloro-4-pyridyl)-N-phenylurea] and the like are included. These may be used alone or in combination of two or more.

Other plant hormones include for example, GA (gibberellin), ABA (abscisic acid), brassinosteroid, jasmonic acid and the like.

Methods of using the sodium bicarbonate and the like of the invention is not particularly limited, however, conventional methods for plant growth regulators such as the soil affusion treatment, addition to the hydroponic solution, coating on seeds, treatment to cuttings may be used. Additionally, combined use with other pesticide or fertilizer is also possible, of course. Therefore, dramatic effects as a soil-improving agent are also exerted. As is described below, by blending the sodium bicarbonate or the like in volcanic ash, for example, modification effects for the soil can be also achieved.

Specific methods for use include a process in which seeds of a plant are immersed in an aqueous sodium bicarbonate solution, followed by seeding in an agricultural field or potting compost to germinate and grow the plant. This process may include a procedure in which the seeds are mixed with a carrier immobilized with sodium bicarbonate, or potting compost containing the same, followed by seeding in an agricultural field or potting compost.

Although applicable target plants are not particularly limited, included are for example, root vegetables such as radish (Raphanus sativus), carrot (Daucus carota), burdock (Arctium lappa); vegetables such as etiolated seedling, lettuce (Lactuca sativa), Chinese cabbage (Brassica campestris), Brassica chinensis komatsuna, strawberry, melon (Cucumis melo); cereal grains such as rice (Oryza sativa), wheat (Triticum aestivum), maize (Zea mays); petal flowers such as chrysanthemum, lily, orchid, rose, pansy, carnation; turfs such as Zoysia, zoysiagrass, pentograss; beans such as garden pea (Pisum sativun), soybean (Glycine max), peanut (Arachis hypogaea); trees such as Japanese cedar (Cryptomeria japonica), Japanese cypress (Chamaecyparis obtusa), azalea (Rhododendron indicum); fruit trees such as tomato (Lycopersicon esculentum), pear (Pyrus pyrifolia), grape (Vitis vinifera), apple (Malus domestica); weeds such as Veronica persica Poir, as representatives thereof.

### BRIEF DESCRIPTION OF THE DRAWINGS

FIG. 1 is a drawing (photograph) illustrating the state of rice in germ within a dish.

FIG. 2 is a drawing (photograph) in which the length of a stalk and a root in germ as shown in FIG. 1 was compared.

FIG. 3 is a drawing (photograph) illustrating the state of tomato in germ within a dish.

FIG. 4 is a drawing (photograph) in which the length of a stalk and a root in germ as shown in FIG. 3 was compared.

FIG. 5 is a drawing (photograph) illustrating the state of lettuce in germ within a dish.

FIG. 6 is a drawing (photograph) in which the length of a stalk and a root in germ as shown in FIG. 5 was compared.

FIG. 7 is a drawing (photograph) illustrating the state of perennial ryegrass in germ within a dish.

FIG. 8 is a drawing (photograph) in which the length of a stalk and a root in germ as shown in FIG. 7 was compared.

FIG. 9 is a drawing (photograph) in which the length of a stalk and a root of radish in germ was compared.

FIG. 10 is a drawing (photograph) in which the length of a stalk and a root of Veronica persica Poir in germ for NaHCO₃ as a control was compared.

FIG. 11 is a drawing (photograph) in which the length of a stalk and a root of tomato in germ for NaHCO₃ as a control was compared.

FIG. 12 is a drawing (photograph) in which the length of a stalk and a root of tomato in germ upon use of NaHCO₃ and auxin in combination was compared.

FIG. 13 is another exemplary drawing (photograph) in which the length of a stalk and a root of tomato in germ upon use of NaHCO₃ and auxin in combination was compared.

FIG. 14 is yet another exemplary drawing (photograph) in which the length of a stalk and a root of tomato in germ upon use of NaHCO₃ and auxin in combination was compared.

FIG. 15 is a drawing (photograph) in which the length of a stalk and a root of Veronica persica Poir in germ upon use of NaHCO₃ and auxin in combination was compared.

FIG. 16 is another exemplary drawing (photograph) in which the length of a stalk and a root of Veronica persica Poir in germ upon use of NaHCO₃ and auxin in combination was compared.

FIG. 17 is another exemplary drawing (photograph) in which the length of a stalk and a root of lettuce in germ for NaHCO₃ using volcanic ash was compared.

### DESCRIPTION OF THE PREFERRED EMBODIMENTS

The present invention is specifically explained below with references to Examples which are made for merely illustrative purpose, and the invention is not limited to these Examples.

1) Effect of NaHCO₃

### EXAMPLE 1

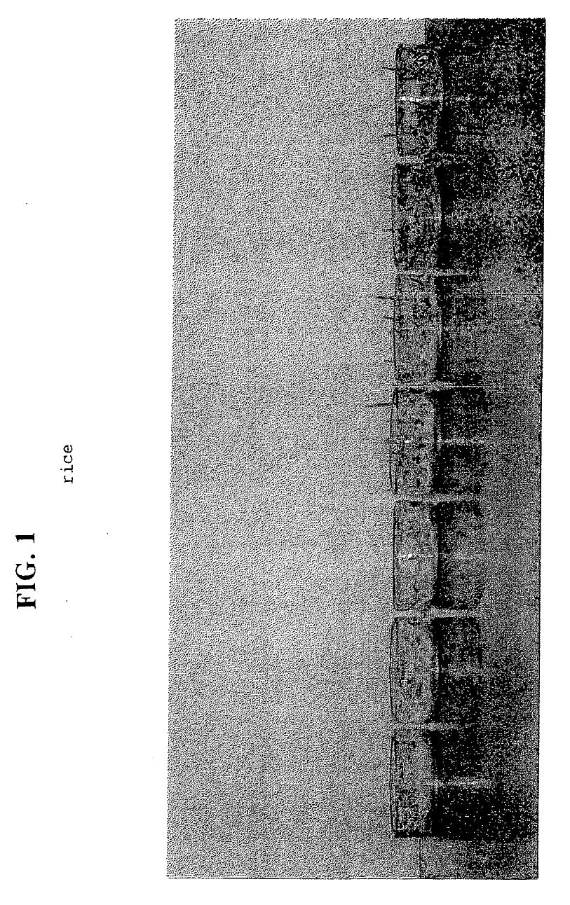

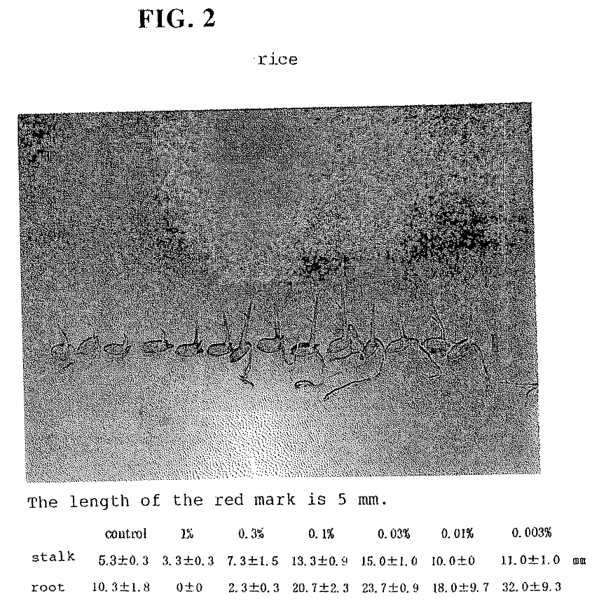

### Rice, FIG. 1 and FIG. 2

The present invention (NaHCO₃) was demonstrated using rice. Absorbent cotton was spread on a 4.5 cm dish, and thereto was added 10 ml of a test liquid. Seeds (10 seeds) were added thereto, grown at 23° C. for 4 days in the dark, and thereafter cultivated at 23° C. for 3 days in the light (about 3000 lux). Each Figure illustrates for NaHCO₃ used as a principal active ingredient showing from the left: control (NaHCO₃ concentration of 0%), 1% (1/10 dilution of a stock solution of an aqueous saturated solution of 10%), 0.3%, 0.1%, 0.03%, 0.01%, and 0,003%.

FIG. 1 is a drawing illustrating the state of seeds within each of the dishes. FIG. 2 is a drawing comparing the length of each shoot (stalk) and the length of each root. The stalks have the length of 5.3±0.3 mm, 3.3±0.3 mm, 7.3±1.5 mm, 13.3±0.9 mm, 15.0±1.0 mm, 10.0±0 mm, 11.0±1.0 mm, respectively. The length of the roots is 10.3±1.8 mm, 0±0 mm, 2.3±0.3 mm, 20.7±2.3 mm, 23.7±0.9 mm, 18.0±9.7 mm, 32.0±9.3 mm, respectively. For reference, the length of the label is 5 mm.

As is clear from FIG. 1 and FIG. 2 as well as the length of each stalk and root, it is revealed that the growth is suppressed when the concentration is high, whilst the growth is accelerated when the concentration is low.

### EXAMPLE 2

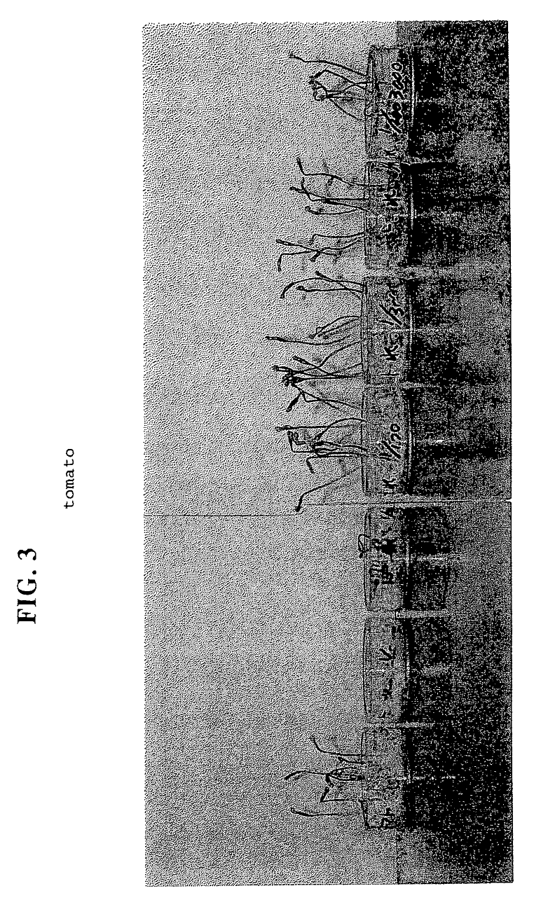

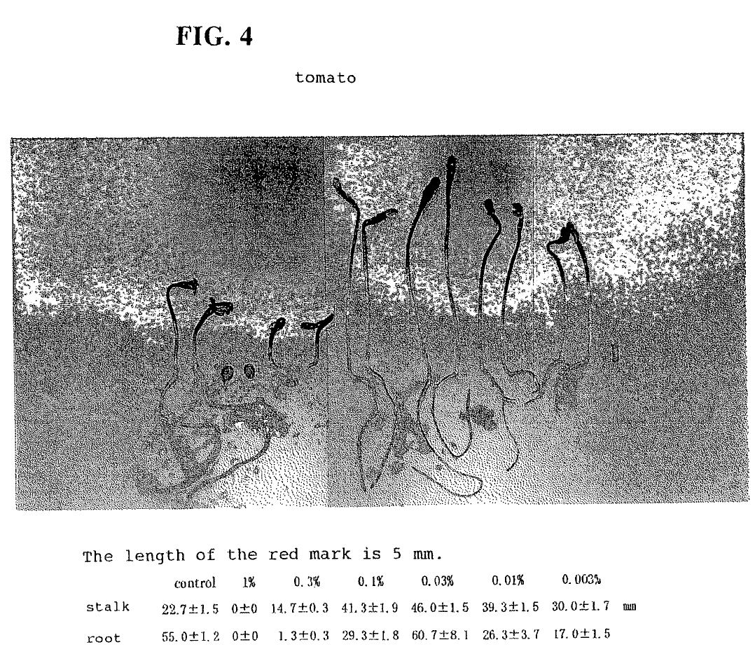

### Tomato, FIG. 3 and FIG. 4

The present invention (NaHCO₃) was demonstrated using tomato. FIG. 3 is a drawing illustrating the state of germination within each of the dishes similarly to FIG. 1. FIG. 4 is a drawing comparing the length of each embryonic axis (stalk) and the length of each root similarly to FIG. 2.

The stalks have the length of 22.7±1.5 mm, 0±0 mm, 14.7±0.3 mm, 41.3±1.9 mm, 46.0±1.5 mm, 39.3±1.5 mm, 30.0±1.7 mm, respectively. The length of the roots is 55.0±1.2 mm, 0±0 mm, 1.3±0.3 mm, 29.3±1.8 mm, 60.7±8.1 mm, 26.3±3.7 mm, 17.0±1.6 mm, respectively. For reference, the length of the label is 5 mm.

As is clear from FIG. 3 and FIG. 4 as well as the length of each stalk and root, it is revealed that the growth is suppressed when the concentration is high, whilst the growth is accelerated when the concentration is 0.1% or less.

### EXAMPLE 3

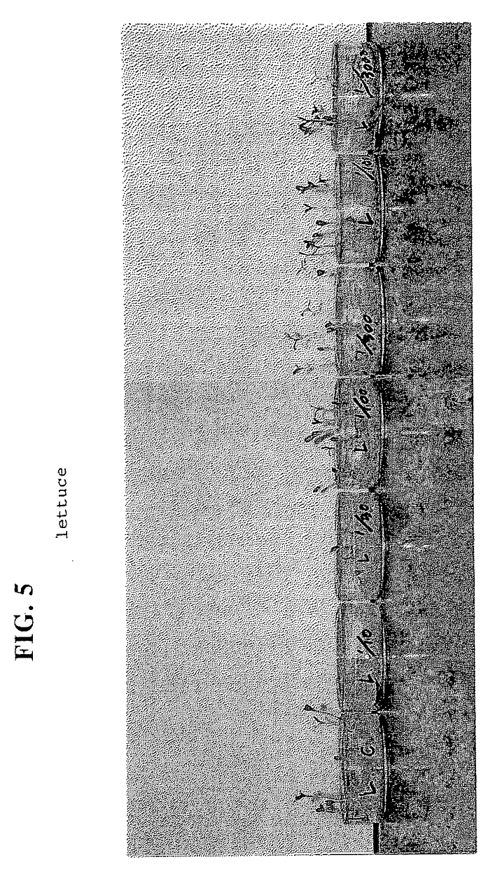

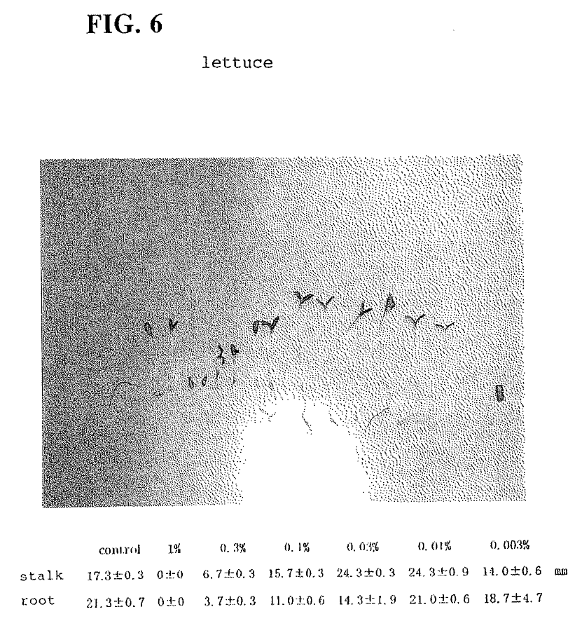

### Lettuce, FIG. 5 and FIG. 6

The present invention (NaHCO₃) was demonstrated using lettuce. FIG. 5 is a drawing illustrating the state of germination within each of the dishes similarly to FIG. 1. FIG. 6 is a drawing comparing the length of each stalk and the length of each root similarly to FIG. 2.

The stalks have the length of 17.3±0.3 mm, 0±0 mm, 6.7±0.3 mm, 15.7±0.3 mm, 24.3±0.3 mm, 24.3±0.9 mm, 14.0±0.6 mm, respectively. The length of the roots is 21.3±0.7 mm, 0±0 mm, 3.7±0.3 mm, 11.0±0.6 mm, 14.3±1.9 mm, 21.0±0.6 mm, 18.7±4.7 mm respectively. For reference, the length of the label is 5 mm.

As is clear from FIG. 5 and FIG. 6 as well as the length of each stalk and root, it is revealed that the growth is suppressed when the concentration is high, whilst the growth is accelerated when the concentration is low.

### EXAMPLE 4

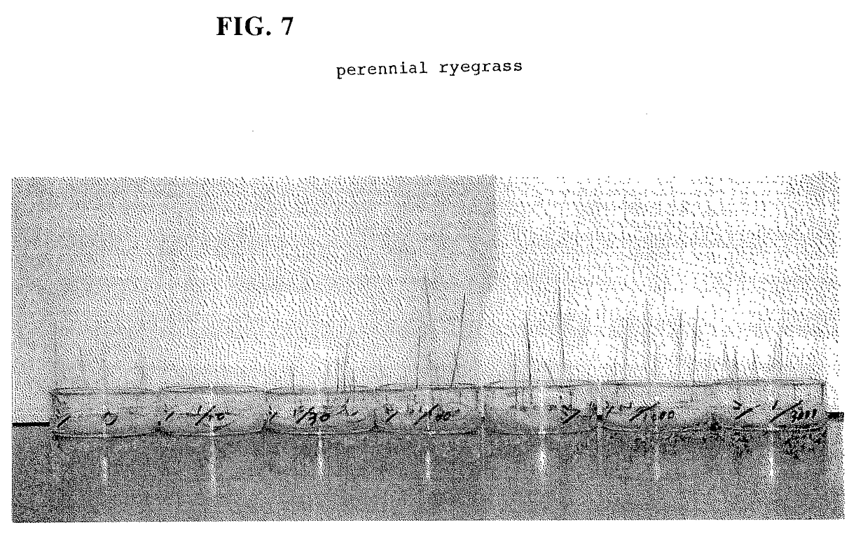

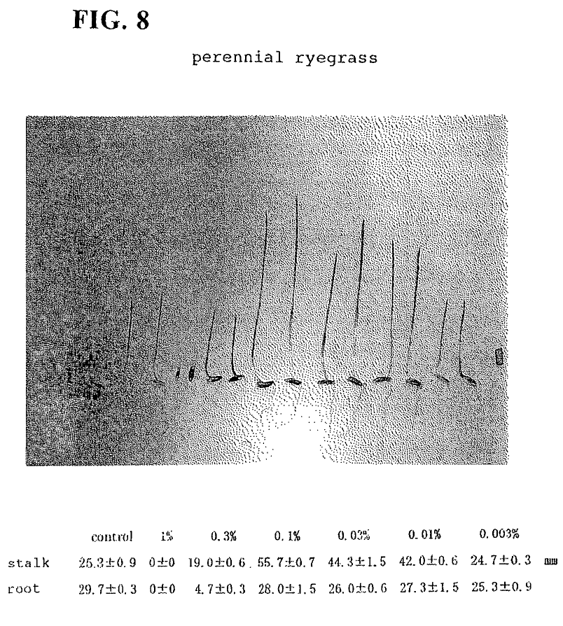

### Perennial Ryegrass, FIG. 7 and FIG. 8

The present invention (NaHCO₃) was demonstrated using perennial ryegrass. FIG. 7 is a drawing illustrating the state of seeds within each of the dishes similarly to FIG. 1. FIG. 8 is a drawing comparing the length of each shoot (stalk) and the length of each root similarly to FIG. 2.

The stalks have the length of 25.3±0.9 mm, 0±0 mm, 19.0±0.6 mm, 55.7±0.7 mm, 44.3±1.5 mm, 42.0±0.6 mm, 24.3±0.3 mm, respectively. The length of the roots is 29.7±0.3 mm, 0±0 mm, 4.7±0.3 mm, 28.0±1.5 mm, 28.0±0.6 mm, 27.3±1.5 mm, 25.3±0.9 mm, respectively. For reference, the length of the label is 5 mm.

As is clear from FIG. 7 and FIG. 8 as well as the length of each stalk and root, it is revealed that the growth is suppressed when the concentration is high, whilst the growth is accelerated when the concentration is low.

### EXAMPLE 5

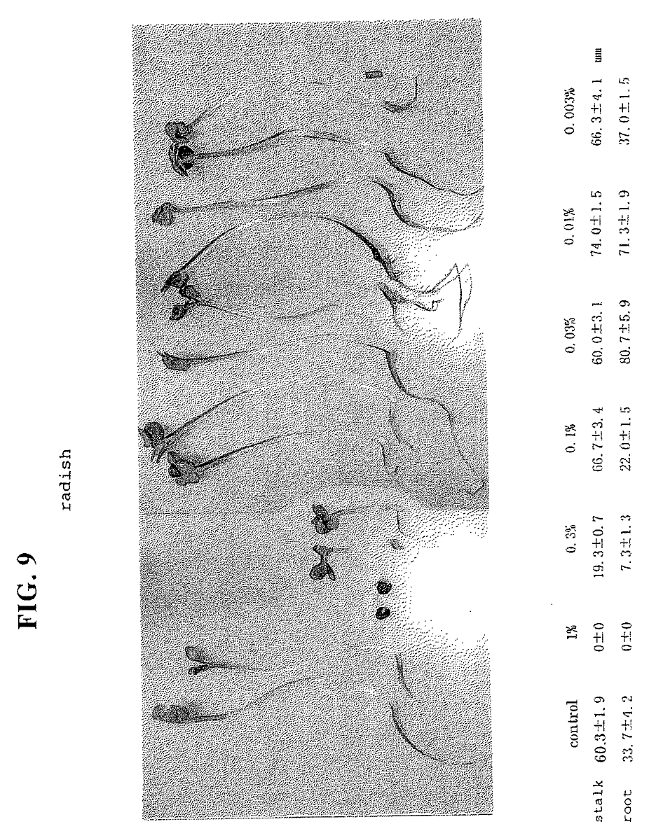

### Radish, FIG. 9

The present invention (NaHCO₃) was demonstrated using radish. FIG. 9 is a drawing comparing the length of each embryonic axis (stalk) and the length of each root similarly to FIG. 2.

The stalks have the length of 60.3±1.9 mm, 0±0 mm, 19.3±0.7 mm, 66.7±3.4 mm, 60.0±3.1 mm, 74.0±1.5 mm, 66.3±4.1 mm, respectively. The length of the roots is 33.7±4.2 mm, 0±0 mm, 7.3±1.3 mm, 22.0±1.5 mm, 80.7±5.9 mm, 71.3±1.9 mm, 37.0±1.5 mm, respectively. For reference, the length of the label is 5 mm.

As is clear from FIG. 9 as well as the length of each stalk and root, it is revealed that the growth is suppressed when the concentration is high, whilst the growth is accelerated when the concentration is low.

2) Effect of KHCO₃ and NaHCO₃ Used In Combination

### EXAMPLE 6

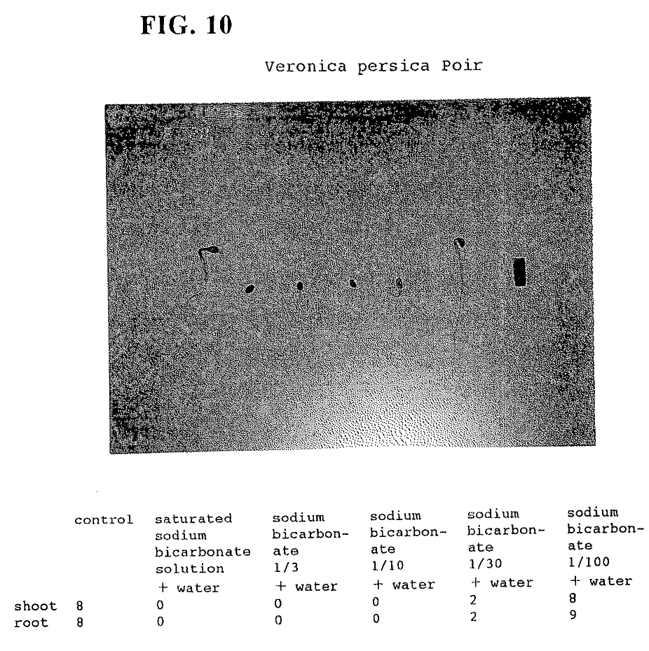

### Veronica Persica Poir, FIG. 10

The present invention (NaHCO₃+KHCO₃) was demonstrated using Veronica persica Poir. FIG. 10 is a drawing illustrating the state of seeds within each of the dishes similarly to FIG. 1, and each control is shown. The Figure illustrates for NaHCO₃ used as a principal active ingredient showing from the left: 0%, 10%, 3%, 1%, 0.3%, and 0.1%. In addition, the length of each embryonic axis (stalk) and the length of each root are indicated.

Experiments were conducted with varying concentrations of KHCO₃ for each concentration of NaHCO₃ shown in FIG. 10. Although not shown in the Figure, when the concentration of KHCO₃ was varied at 0% of NaHCO₃, the length of the stalk and root was 0 mm at 1% of KHCO₃, but became 7 mm and 10 mm respectively at 0.1%, which were approximately identical to the values for 0.1% of NaHCO₃.

Next, the experiments were conducted with varying concentrations of KHCO₃ (0.1 to 10%) when the concentration of NaHCO₃ was 10%, 3%, 1% and 0.3%. Thus resulting length of the stalk and root was 0 mm. Moreover, when similar tests were carried out for 0.1% of NaHCO₃, the development of the stalk and root was not found at 10 to 1% of KHCO₃, however, at 0.1% of KHCO₃, the length of the stalk became 10 mm and the length of the root became 18 mm. These results suggest that more remarkable growth was achieved than the control (FIG. 10) for 0.1% of NaHCO₃ (stalk: 8 mm, root: 9 mm) and for 0.1% of KHCO₃ (stalk: 7 mm, root: 10 mm). Accordingly, the effects by combined use of both compounds were demonstrated.

### EXAMPLE 7

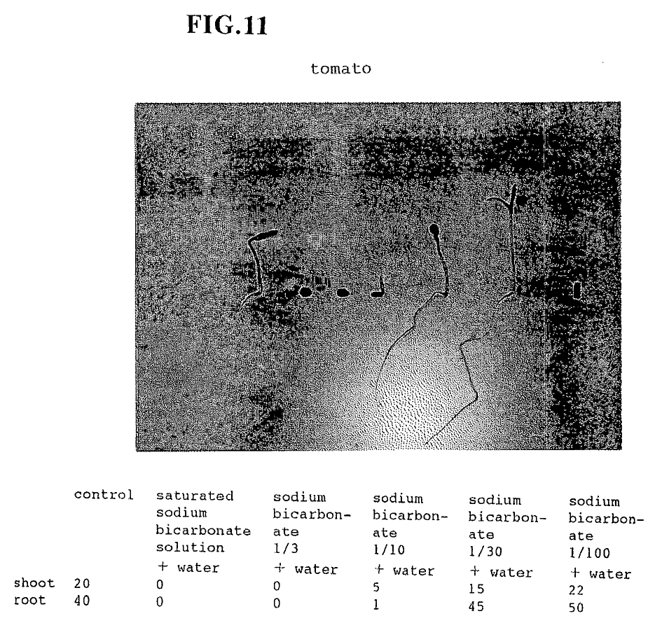

### Tomato, FIG. 11

The present invention (NaHCO₃+KHCO₃) was demonstrated using tomato. FIG. 11 is a drawing illustrating the state of seeds within each of the dishes similarly to FIG. 1, and each control is shown. The Figure illustrates for NaHCO₃ used as a principal active ingredient showing from the left: 0%, 10%, 3%, 1%, 0.3%, and 0.1%. In addition, the length of each stalk and the length of each root are presented.

Experiments were conducted with varying concentrations of KHCO₃ for each concentration of NaHCO₃ shown in FIG. 11. Although not shown in the Figure, when the concentration of KHCO₃ was varied at 0% of NaHCO₃, the length of the stalk and root was 0 mm at 1% of KHCO₃, became 40 mm and 62 mm respectively at 0.1%, which revealed greater effects than those suggested by the values for 0.1% of NaHCO₃.

Next, the experiments were conducted with varying concentrations of KHCO₃ (0.1 to 10%) when the concentration of NaHCO₃ was 10% and 3%. Thus resulting length of the stalk and root was 0 mm. Moreover, when similar tests were carried out for 1% of NaHCO₃, the development of the stalk and root was not found at 10% or 0.1% of KHCO₃, however, at 1% of KHCO₃, the length of the stalk became 11 mm and the length of the root became 5 mm. These reveal greater effects than the control (FIG. 11) for 1% of NaHCO₃ (stalk: 5 mm, root: 1 mm). In addition, when KHCO₃ was used at 10% for 0.1% of NaHCO₃₁ the development of the stalk and root was 0 mm. However, when the length of the stalk was 2 mm and the length of the root was 0.1 mm, 1% of KHCO₃ resulted in the length of the stalk of 45 mm and the length of the root of 50 mm. Accordingly, the effects by combined use of both compounds are remarkable.

3) Effect of Auxin Used in Combination

### EXAMPLE 8

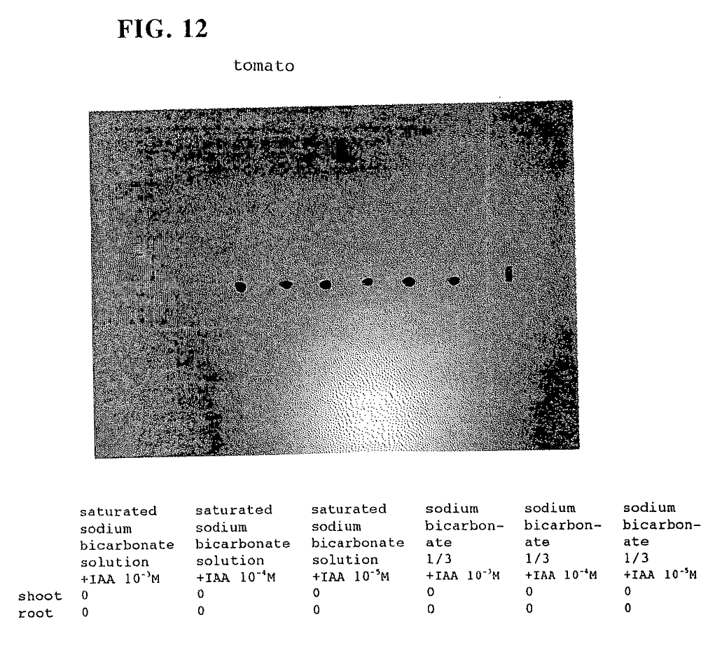

### Tomato, FIGS. 12 to 14

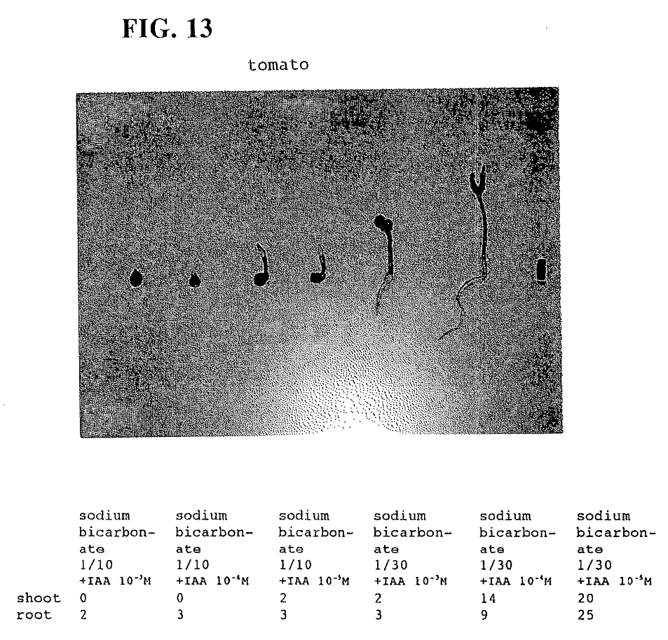

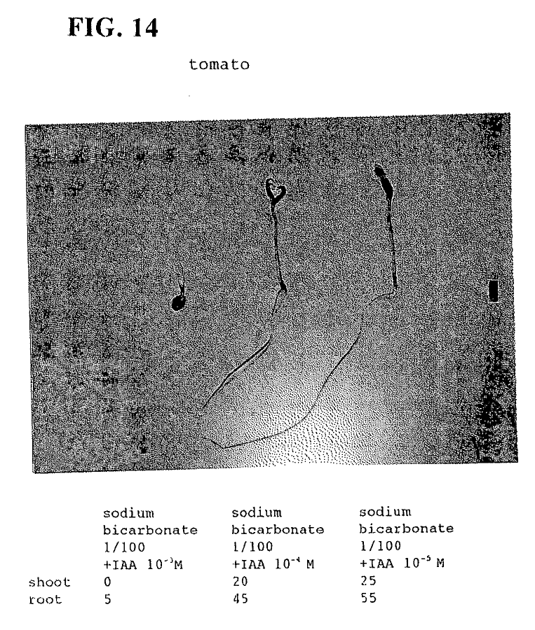

The present invention (auxin used in combination) was demonstrated using tomato. Indole-3-acetate (IAA) was used as the auxin. When IAA was used at 10⁻⁴ to 10⁻⁵ M, although not shown in the Figures, the length of each stalk was 20 mm, 23 mm, and the length of each root was 30 mm, 41 mm, respectively. Thus, when the cases of use in combination with NaHCO₃ were examined, as is shown in FIG. 12, in the instances of 10% or 3% of NaHCO₃ and 10⁻³ to 10⁻⁵ M of IAA were used, any of the length of the stalk and root was 0 mm. FIG. 13 is a photograph illustrating the instances where 1% or 0.3% of NaHCO₃ and 10⁻³ to 10⁻⁵ M of IAA were used. Moreover, FIG. 14 is a photograph illustrating the instances where 0.1% of NaHCO₃ and 10⁻³ to 10⁻⁵ M of IAA were used. According to these Figures, it was revealed that when both compounds were used at a predetermined ratio, the root especially became strong. As the foregoing, when NaHCO₃ and IAA were used in combination, the effects of the combined use are prominent, including the inhibition of the growth and the acceleration of the growth of the plant. In particular, it is proven that when NaHCO₃ was used at 0.1%, IAA at the concentration of approximately 10⁻⁴ to 10⁻⁶ M greatly contributes to the growth of the plant.

### EXAMPLE 9

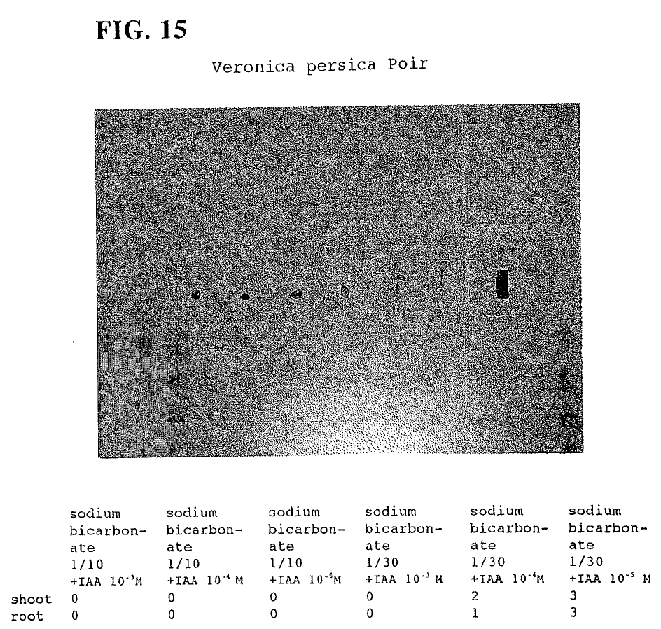

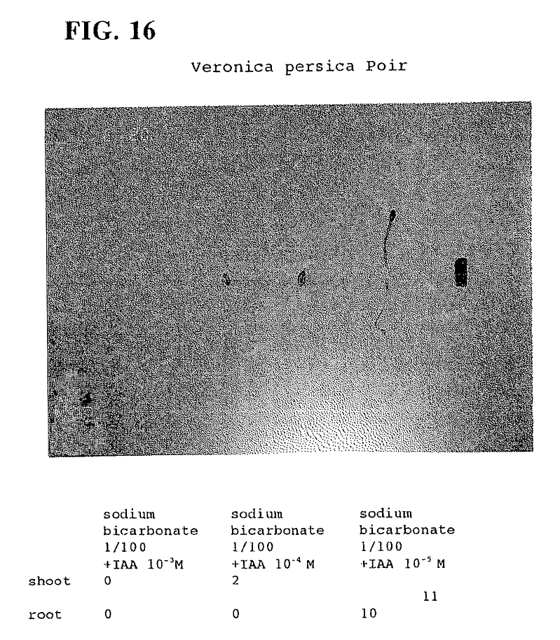

### Veronica Persica Poir, FIGS. 15 to 16

The present invention (auxin used in combination) was demonstrated using Veronica persica Poir. Indole-3-acetate (IAA) was used as the auxin. When IAA was used at 10⁻⁴ to 10⁻⁵ M, although not shown in the Figures, the length of each stalk was 8 mm, 13 mm, and the length of each root was 11 mm, 22 mm, respectively. Thus, when the cases of use in combination with NaHCO₃ were examined, in the instances of 10% or 3% of NaHCO₃ and 10⁻³ to 10⁻⁵ M of IAA were used, any of the length of the stalk and root was 0 mm. FIG. 15 is a photograph illustrating the instances where 1% or 0.3% of NaHCO₃ and 10⁻³ to 10⁻⁵ M of IAA were used. Moreover, FIG. 16 is a photograph illustrating the instances where 0.1% of NaHCO₃ and 10⁻³ to 10⁻⁵ M of IAA were used. According to these Figures, it is proven that when NaHCO₃ and IAA were used in combination, the effects of the combined use are prominent including the inhibition of the growth and the acceleration of the growth of the plant.

### EXAMPLE 10

### Modification of Volcanic Ash

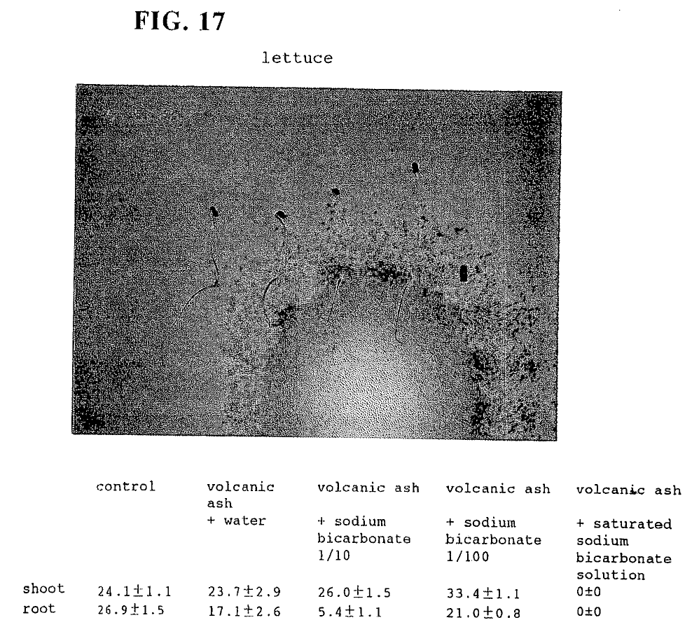

NaHCO₃ was blended in volcanic ash (originated in Hokkaido, Chitose), and the germination of lettuce was thereby accelerated. For control 1, absorbent cotton was spread on a 4.5 cm dish, and thereto was added 10 ml of water. Seeds (10 seeds) were added thereto, grown at 23° C. for 4 days in the dark, and thereafter cultivated at 23° C. for 3 days in the light (about 3000 lux). The length of the stalk and root was as shown in FIG. 17. Control was for water alone, resulting in the length of the stalk and root of 24.1±1 mm and 26.9±1.5 mm. Additionally, when the lettuce seeds were seeded to the soil which was prepared by adding water to the volcanic ash (volcanic ash: 100 g and water: 28 g), the length of the stalk and root was 23.7±2.9 mm and 17.1±2.6 mm.

However, for the soil including the volcanic ash +10% NaHCO₃ (volcanic acid: 100 g and saturated sodium bicarbonate solution: 28 g), the development of the stalk and root was 0 mm. Moreover, for the soil including the volcanic ash +1% NaHCO₃ (volcanic acid: 100 g and 1% NaHCO₃ solution: 28 g), the length of the stalk and root was 26.0±1.5 mm and 5.4±1.1 mm. Further, for the soil including the volcanic ash +0.1% NaHCO₃ (volcanic acid: 100 g and 0.1% NaHCO₃ solution: 28 g), the development of the stalk and root was 33.4±1.1 mm and 21.1±0.8 mm.

According to these results, adding NaHCO₃ to the soil contributes to the growth of a plant. Thus, the modification of volcanic ash such as whitebait, and red soil was enabled. Of course, it goes without mentioning that modification of soil can be practiced by use of NaHCO₃ alone, and use thereof in combination with KHCO₃, as well as use in combination with a plant hormone.

### INDUSTRIAL APPLICABILITY

The plant growth regulator of the present invention exerts dramatic effects as described herein above, and is readily available. Furthermore, the plant growth regulator of the invention is characterized by not adversely affecting the soil and being friendly to the environment, and thus the usefulness thereof is eminent.

1. A growth regulator of a plant comprising NaHCO₃ and/or KHCO₃ as a principal active ingredient.

2. The growth regulator of a plant according to claim 1 wherein a plant hormone is added as an active ingredient.

3. The growth regulator of a plant according to claim 2 wherein said plant hormone is auxin.

4. A process for the growth regulation of a plant wherein 0.003 to 1% by weight of NaHCO₃ and/or KHCO₃ is included in a germination and nursery bed of a plant.

5. The process for the growth regulation of a plant according to claim 4 wherein 10⁻³ to 10⁻⁷ M of a plant hormone is included.

6. The process for the growth regulation of a plant according to claim 5 wherein said plant hormone is auxin.
